(19) United States
(12) Patent Application Publication
(10) Pub. No.: US 2005/0106323 A1
(43) Pub. Date: May 19, 2005

(54) Film forming method, film forming machine, device manufacturing method, device manufacturing apparatus, and device and electronic equipment

(75) Inventor: Hirotsuna Miura, Suwa-gun (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/960,036

(22) Filed: Oct. 8, 2004

(30) Foreign Application Priority Data
Oct. 29, 2003 (JP) 2003-369060

(51) Int. Cl. B05D 3/12; B32B 9/04

(52) U.S. Cl. 427/346; 427/421.1; 428/411.1

(57) ABSTRACT

Exemplary embodiments easily form a planar thin film having a uniform film thickness. A plurality of droplets are applied to the substrate to manufacture a film. The film forming method includes applying the droplets to the substrate in a plurality of sizes, and vibrating the droplets on the substrate with vibration properties different from each other.

### BACKGROUND OF THE INVENTION

1. Field of Invention

Exemplary embodiments of the present invention relate to a film forming method, a film forming machine, a device manufacturing method, a device manufacturing apparatus, and a device and electronic equipment.

2. Description of Related Art

The usage of liquid crystal display devices, and in particular color liquid crystal display devices, has increased with the development of electronic equipment, such as computers and portable information equipment terminals. In this type of liquid crystal display device, a color filter is used to colorize a display image. In some color filters, a substrate is provided and inks (droplets) of R (red), G (green) and B (blue) are landed on this substrate in a predetermined pattern and these inks are dried on the substrate, thereby forming a coloring layer. As a method of landing the inks on, and applying to, the substrate, for example, a drawing machine by an ink-jet method (droplet discharging method) is employed.

In the case where the ink-jet method is employed, in the drawing machine, a predetermined amount of ink is discharged from a droplet discharging head and is landed on a filter. In this case, for example, the substrate is mounted on a Y stage (a stage movable in a Y direction), and the droplet discharging head is mounted on an X stage (a stage movable in an X direction). After the droplet discharging head is positioned in a predetermined position by driving the X stage, the ink is discharged while moving the substrate relatively to the droplet discharging head by driving the Y stage, thereby enabling the ink from a plurality of droplet discharging heads to be landed at predetermined positions of the substrate.

On the above-mentioned substrate, a protective film composed of a thin film may be formed for protection and planarization of a surface thereof. In the case where the above-mentioned droplet discharging method is used to form the protective film, a problem occurs in that, since surface tension makes it hard to uniformly spread the ink landed on the substrate, a film profile thereof becomes irregular, and thus it is hard to form a planar thin film having a uniform film thickness.

Accordingly, the present applicant has proposed a technique of fusing the droplets by applying vibration to the substrate with the droplets landed so as to uniformize the film thickness (see Japanese Unexamined Patent Publication No. 2003-260389).

### SUMMARY OF THE INVENTION

The above-mentioned related art, however, is subject to the following problem.

A plurality of droplets landed on the substrate have almost the same vibration properties and thus vibrate in the same phase, which causes a problem in that the adjacent droplets do not sufficiently fuse with together. In particular, in the case where droplet discharge is performed using a liquid with high viscosity, this tendency is remarkable.

Thus, when the fusion is insufficient, the irregularity becomes large, which may have adverse effects on properties of an element having the film. Furthermore, when the relative movement between the head and the substrate starts a new line, there is a possibility that a slight step is caused along the line feed position, deteriorating display quality as a so-called line feed streak.

The present invention addresses the above-mentioned and/or other points, and provides a film forming method in which a planar thin film having a uniform film thickness can be easily formed, a film forming machine, a device manufacturing method, a device manufacturing apparatus, and a device and electronic equipment.

In order to address or achieve the above, exemplary embodiments of the present invention employ the following exemplary structures.

A film forming method of an exemplary embodiment of the present invention is a method of applying a plurality of droplets on a substrate to form a film, including applying the droplets to the substrate in a plurality of sizes; and vibrating the droplets on the substrate with vibration properties different from each other.

Accordingly, in an exemplary embodiment of the present invention, since the adjacent droplets vibrate in different phases (cycles) according to the sizes of the droplets, the droplets easily collide with each other to be fused. Furthermore, the fusion brings about a larger droplet, thereby changing the vibration cycle, and thus even more easily collides with another droplet to be fused. By fusing all the droplets, a thin film having a uniform film thickness can be formed. As a result, adverse effects on properties of an element having this thin film can be reduced or prevented.

In order to vibrate with vibration properties different from each other, it is preferable to be vibrated at a frequency (resonance frequency) based on a natural frequency of the droplet of at least one size among the droplets of a plurality of sizes. In this case, as compared with the droplets of the other sizes, the relevant droplet moves largely and time until resonance can be shortened.

Furthermore, it is preferable that the frequency for vibration is changed in a range including all the natural frequency corresponding to the sizes of the droplets.

In this case, since all the droplets of different sizes can be vibrated at the resonance frequency, when applying the vibration of the corresponding frequency, the relevant droplet is moved largely, and thus the fusion of all the droplets can be promoted and the film thickness can be more uniform.

Furthermore, in this case, since the fusion of the droplets brings about the larger droplet, thereby decreasing the natural frequency, the frequency in vibrating the droplets is preferably changed from a higher value to a lower value.

Furthermore, an exemplary embodiment of the present invention can also employ a procedure including applying a first droplet group made of droplets of a plurality of sizes within a first range along a first direction; applying a second droplet group made of droplets of a plurality of sizes within a second range different from the first range along a second direction; applying vibration in the first direction at a frequency based on a natural frequency of the droplets of the sizes within the first range; and applying vibration in the second direction at a frequency based on a natural frequency of the droplets of the sizes within the second range.

Thereby, by applying the vibration at the frequency corresponding to the sizes of the droplets within the first range, the droplets of the first droplet group can collide with each other and be fused to form a linear thin film extending in the first direction. At this time, the droplets of the second droplet group, being different from the fist droplet group in size, hardly move. Similarly, by applying the vibration at the frequency corresponding to the sizes of the droplets within the second range, the droplets of the second droplet group can collide with each other and be fused to form a linear thin film extending in the second direction. That is, by selecting the vibration direction and the frequency as necessary, the linear patterns extending in the first direction and the second direction can be formed.

On the other hand, a device manufacturing method of the present invention includes forming a thin film on a substrate. The film forming includes using the above-mentioned film forming method.

A device of the present invention is manufactured by the above-mentioned device manufacturing method.

In addition, electronic equipment of the present invention includes the above-mentioned device.

Accordingly, in an exemplary embodiment of the present invention, a planar thin film with less irregularity and having a uniform film thickness can be formed on the substrate, and thus a device and electronic equipment that are excellent in quality, such as display quality, can be attained.

A film forming machine of the present invention is used with a droplet discharging head discharging droplets on a substrate, and includes a control device to control the drive of the droplet discharging head to discharge the droplets on the substrate in a plurality of sizes; and a vibration applying device to vibrate the droplets on the substrate with different vibration properties.

Accordingly, in the present invention, since the adjacent droplets vibrate in different phases (cycles) according to the sizes, the droplets easily collide with each other to be fused. Furthermore, the fusion brings about a larger droplet, thereby changing the vibration cycle, and thus even more easily collides with another droplet to be fused. By fusing all the droplets, a thin film having a uniform film thickness can be formed. As a result, adverse effects on properties of an element having this thin film can be reduced or prevented.

Furthermore, a device manufacturing apparatus of the present invention includes a film forming machine forming a thin film on a substrate. The film forming machine includes the above-mentioned film forming machine.

Accordingly, in an exemplary embodiment of the present invention, a planar thin film with less irregularity having a uniform film thickness can be formed on the substrate, and thus a device that is excellent in quality, such as display quality, can be attained.

### BRIEF DESCRIPTION OF THE DRAWINGS

FIG. 1 is a schematic perspective view of a droplet applying device according to an exemplary embodiment of the present invention;

FIG. 2 is a partial cross-sectional view in which a holder is set up on a table via piezo actuators;

FIG. 3 is a schematic showing an arrangement relationship between the holder and the piezo actuators;

FIGS. 4A-4F are schematics explaining a discharge principle of a liquid by a piezo method;

FIG. 5 is a schematic in which droplets different from each other in size are applied;

FIGS. 6A-6C are schematics in which the droplets on the substrate vibrate;

FIG. 7 is a cross-sectional view in which a film is formed with a uniform thickness on the substrate;

FIGS. 8A-8C are schematics in which the droplets different from each other in size are fused;

FIGS. 9A-9C are schematics explaining an operation for forming films extending in an X axial direction and in a Y axial direction;

FIG. 10 is a schematic circuit diagram of a switching element, a signal line or the like to which an exemplary embodiment of the present invention is applied;

FIG. 11 is a plan view showing a structure of a TFT array substrate to which an exemplary embodiment of the present invention is applied;

FIG. 12 is a partial cross-sectional view of a liquid crystal display device to which an exemplary embodiment of the present invention is applied;

FIG. 13 is a schematic of a color filter to which an exemplary embodiment of the present invention is applied;

FIGS. 14A-14F are schematics of the color filter to which an exemplary embodiment of the present invention is applied; and

FIGS. 15A-15C are schematics of exemplary electronic equipment of exemplary embodiments of the present invention.

### DETAILED DESCRIPTION OF PREFERRED EMBODIMENTS

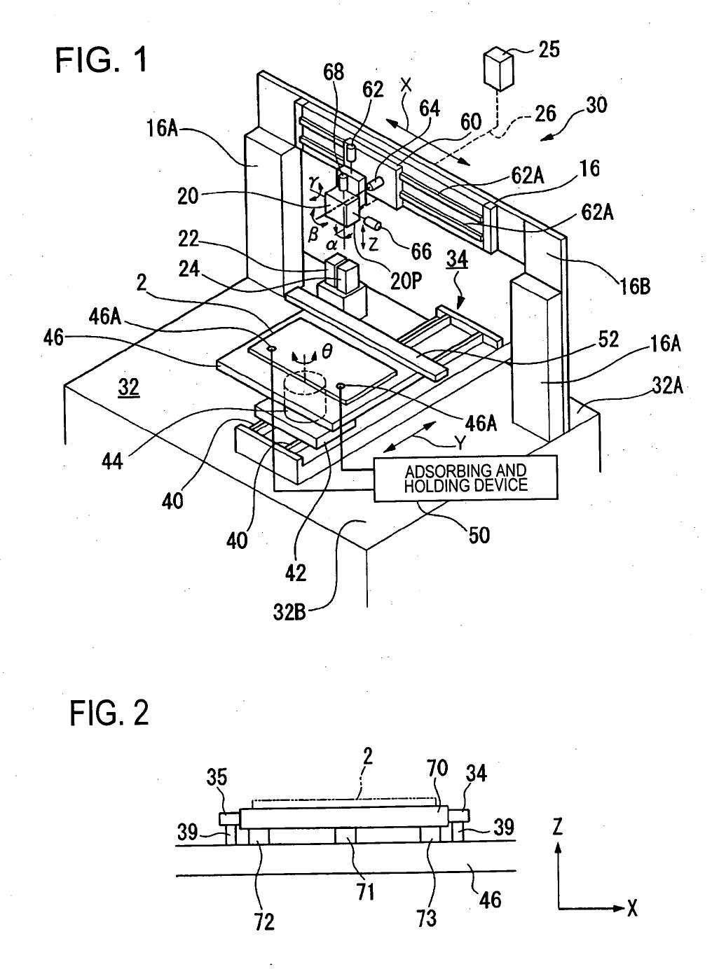

Exemplary embodiments of a film forming method, a film forming machine, a device manufacturing method, a device manufacturing apparatus, and a device and electronic equipment of the present invention are described referring to FIGS. 1 through 15C.

### First Exemplary Embodiment

Firstly, the film forming machine provided in the device manufacturing apparatus is described.

FIG. 1 is a schematic exterior perspective view of a droplet applying device 30 as the film forming machine.

The droplet applying device 30 has a base 32, a first moving device 34, a second moving device 16, an electronic balance not shown in the figure (a weight measuring device), a droplet discharging head 20, a capping unit 22, a cleaning unit 24 or the like. The first moving device 34, the electronic balance, the capping unit 22, the cleaning unit 24 and the second moving device 16 are set up on the base 32, respectively.

The first moving device 34 is preferably set up directly on the base 32, and this first moving device 34 is positioned along a Y axial direction. In contrast, the second moving device 16 is mounted upright with respect to the base 32 using supporting columns 16A and 16A, and the second moving device 16 is mounted to a rear part 32A of the base 32. An X axial direction of the second moving device 16 is a direction perpendicular to the Y axial direction of the first moving device 34. The Y axis is an axis along a direction of a front part 32B and the rear part 32A of the base 32. In contrast, the X axis is an axis along a lateral direction of the base 32. Both of the directions are horizontal.

The first moving device 34 has guide rails 40 and 40, and as the first moving device 34, for example, a linear motor can be employed. A slider 42 of the first moving device 34 in this linear motor form can be moved along the guide rails 40 in the Y axial direction to be positioned. A table 46 is intended to position and hold a substrate 2 as a work. Furthermore, the table 46 has a sucking and holding device 50, and by actuating the adsorbing and holding device 50, the substrate 2 can be adsorbed through hole 46A of the table 46 to be held on the table 46. In the table 46, a preliminary discharging area 52 for waste discharging or trial discharging of ink (preliminary discharge) by the droplet discharging head 20 is provided.

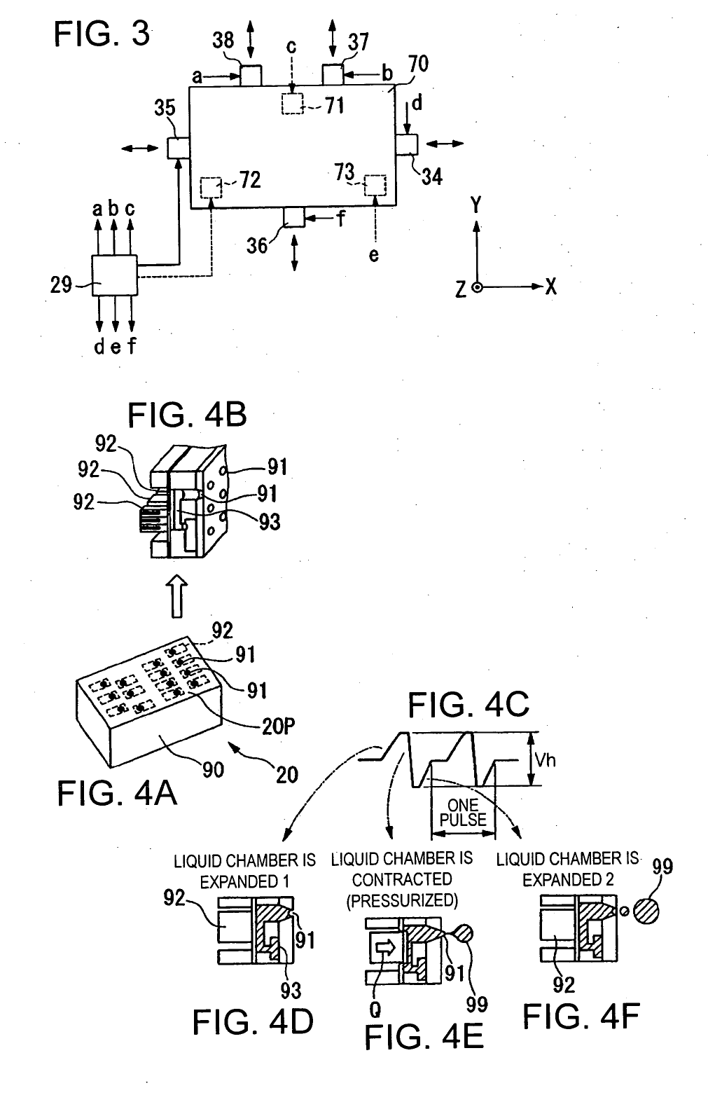

Although omitted in FIG. 1, the substrate 2 is actually held on a rectangular holder 70 placed on the table 46 via piezo actuators (vibration applying device) 71 through 73, as shown in FIG. 2. The piezo actuators 71 through 73 are structured to expand and contract independently in a Z direction which is a droplet discharging direction under control of a control device 29 (refer to FIG. 3), and as shown in FIG. 3, the piezo actuator 71 is arranged on the lower side (−Z side) of the holder 70 and at an edge central part on the +Y side. The piezo actuators 72 and 73 are arranged on the lower side of the holder 70 and at both sides of edge on the −Y side with a space therebetween.

Furthermore, on side of the holder 70, piezo actuators (vibration applying devices) 34 through 35, and 36 through 38 supported on the table 46 via supports 39 (refer to FIG. 2; in FIG. 2, only the piezo actuators 34 and 35 are shown) are provided in a contacting state. The piezo actuators 34 through 35 are structured so as to be arranged at central parts on both sides in the X direction while interposing the holder 70, respectively, and so as to expand and contract independently in the X direction which is a direction along the surface of the substrate 2, under control of the control device 29.

The piezo actuator 36 is arranged at a central part on the −Y side of the holder 70 and the piezo actuators 37 and 38 are arranged on the +Y side of the holder 70 with a space therebetween. These piezo actuators 34-38 are structured so as to expand and contract independently in the Y direction which is a direction along the surface of the substrate 2, under control of the control device 29.

The second moving device 16 has a column 16B fixed to the supporting columns 16A and 16A, and in this column 16B, the second moving device 16 in linear motor form is provided. A slider 60 can be moved along guide rails 62A in the X axial direction to be positioned, and in the slider 60, the droplet discharging head 20 as droplet discharging device is provided.

The slider 42 includes a motor 44 for q axis. This motor 44 is a direct drive motor, for example, and a rotor of the motor 44 is fixed to the table 46. Thereby, by energizing the motor 44, the rotor and the table 46 can be rotated along a q direction to index (rotation index) the table 46.

The droplet discharging head 20 has motors 62, 64, 66 and 68 for oscillation positioning. The actuation of the motor 62 allows the droplet discharging head 20 to be moved up and down along the Z axis so as to be positioned. This Z axis is a direction (vertical direction) perpendicular to the X axis and the Y axis, respectively. The actuation of the motor 64 allows the droplet discharging head 20 to oscillate along a β direction around the Y axis so as to be positioned. The actuation of the motor 66 allows the droplet discharging head 20 to oscillate in a γ direction around the X axis so as to be positioned. The actuation of the motor 68 allows the droplet discharging head 20 to oscillate in a α direction around the Z axis so as to be positioned.

In this manner, the droplet discharging head 20 in FIG. 1 can be linearly moved in the X axial direction via the slider 60 so as to be positioned, and can be oscillated along the α, β, γ so as to be positioned. An ink discharging surface 20P of the droplet discharging head 20 can control the exact position or posture with respect to the substrate 2 on the table 46 side. In the ink discharging surface 20P of the droplet discharging head 20, there are provided a plurality of nozzles (for example, 120 nozzles) as discharging parts, each discharging ink.

A structural example of the droplet discharging head 20 is described referring to FIGS. 4A-4F. The droplet discharging head 20 is a head using piezo actuators (piezoelectric actuators), for example, and as shown in FIG. 4A, in the ink discharging surface 20P of a head body 90, a plurality of nozzles (discharging parts) 91 are formed. A piezo actuator 92 is provided for each of these nozzles 91. As shown in FIG. 4B, the piezo actuator 92 is arranged corresponding to the nozzle 91 and an ink chamber 93, and is structured to be located between a pair of electrodes (not shown), for example, and to be bent in such a manner as to be projected outward by energizing. By impressing an applied voltage Vh to this piezo actuator 92, as shown in FIG. 2C, the piezo actuator 92 is expanded and contracted in an arrow Q direction to thereby pressurize the ink and allow a predetermined amount of droplet (ink droplet) 99 to be discharged from the nozzle 91, as shown in FIGS. 4D, 4E and 4F. The drive of such a piezo actuator 92, that is, the droplet discharge from the droplet discharging head 20 is controlled by the control device 25 (refer to FIG. 1).

Referring to FIG. 1, the electronic balance receives 5000 ink droplets, for example, from the nozzle of the droplet discharging head 20 in order to measure and manage a weight of one droplet discharged from the nozzle of the droplet discharging head 20. The electronic balance divides the weight of the 5000 droplets by 5000, thereby measuring the weight of one droplet substantially precisely. Based on this measured amount of the droplet, the amount of the droplets discharged form the droplet discharging head 20 can be controlled optically.

In the droplet applying device 30 having the above-mentioned structure, the vibration application by driving the piezo actuators 34-38, 71-73 are first described.

With regard to the respective piezo actuators 34-38, 71-73, when a drive voltage is impressed at a predetermined frequency and a drive waveform by the control device 29, they are expanded and contracted at a cycle or a stroke corresponding to this drive voltage, and this expansion and contraction is transmitted to the substrate 2 via the holder 70 in contact with them. In other words, the piezo actuators 34-38, and 71-73 apply vibration of a frequency and an amplitude corresponding to the drive voltage to the substrate 2.

For example, in the case where the piezo actuators 71-73 are driven at the same drive voltage (hereinafter, referred to as vibration parameters, such as a frequency, an amplitude and a phase), the vibration in the Z direction can be applied to the substrate 2, and in the case where the piezo actuators 72 and 73 are driven at the same vibration parameters and the piezo actuator 71 is driven at vibration parameters different from those, vibration in a rotative direction around an axis parallel to the X axis can be applied to the substrate 2. Furthermore, by adjusting the vibration parameters of these piezo actuators 71-73, vibration in a rotative direction around an axis parallel to the Y axis can be applied to the substrate 2.

Furthermore, in the case where the piezo actuators 34 and 35 are driven at phase-shifted vibration parameters, vibration in the X direction can be applied to the substrate 2, and in the case where the piezo actuators 37 and 38 are driven at the same vibration parameters, and the piezo actuator 36 is driven at phase-shifted vibration parameters from these, the vibration in the Y direction can be applied to the substrate 2. Furthermore, by adjusting the vibration parameters of these piezo actuators 36-38, vibration in a rotative direction around an axis parallel to the Z axis can be applied to the substrate 2.

That is, by controlling the vibration parameters of the piezo actuators 34-38, and 71-73, vibration can be applied to the substrate 2 with six-degree-of-freedom of the X direction, the Y direction, the Z direction, the rotative direction around the X axis, the rotative direction around the Y axis, and the rotative direction around the Z axis.

Subsequently, a process of applying the droplets on the substrate 2 by the above-mentioned droplet applying device 30 is described.

When the substrate 2 is fed on the table 46 of the first moving device 34 from a front end side of the table 46, this substrate 2 is adsorbed and held to be positioned with respect to the table 46. Then, the motor 44 is actuated to make setting so that end surfaces of the substrate 2 are parallel to the Y axial direction.

Next, the substrate 2 is moved in the Y axial direction by the first moving device 34 as necessary to be positioned and the droplet discharging head 20 is moved in the X axial direction by the second moving device 16 as necessary to be positioned. Then, after preliminarily discharging the droplets from all the nozzles to the preliminary discharging area 52, the droplet discharging head 20 moves to a discharging start position with respect to the substrate 2.

Then, the droplet discharging head 20 and the substrate 2 are relatively moved on a predetermined track in the Y axial direction (actually, the substrate 2 is moved in the −Y direction with respect to the droplet discharging head 20), and the droplets are discharged to a predetermined region (predetermined positions) on the substrate 2 surface from the nozzles 91.

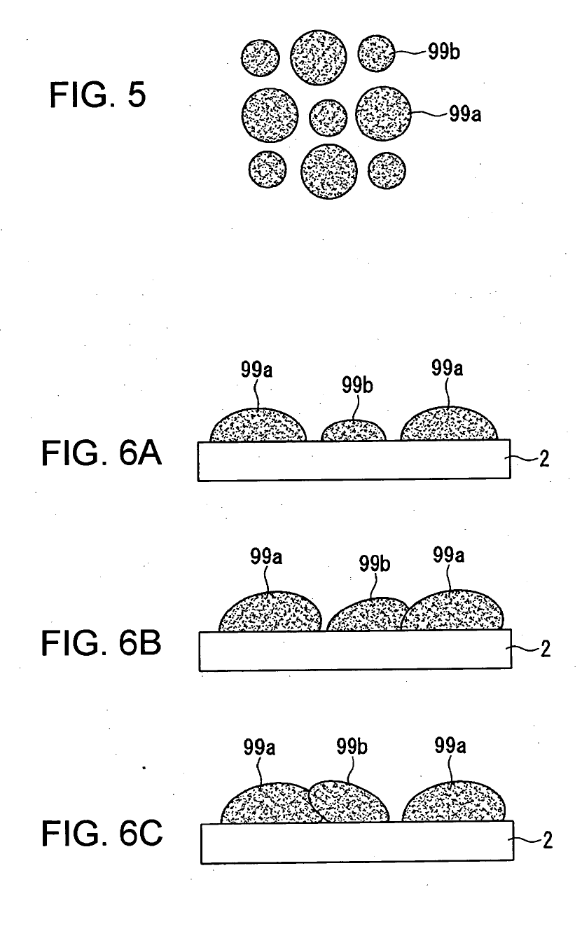

At this time, the control device 25 controls a drive voltage (drive waveform) with respect to the piezo actuator 92 of the droplet discharging head 20, and as shown in FIG. 5, discharges droplets 99a and 99b which are differentiated in size. Here, the droplets of two sizes are set, and with the droplet having a large diameter defined as the droplet 99a and the droplet having a small diameter defined as the droplet 99b, a description is provided.

Furthermore, the control device 25 controls the drive of the droplet discharging head 20 (the piezo actuator 92) and the drive of the first moving device 34 and the second moving means 16 so that the droplet 99a and the droplet 99b different in size are adjacent to each other.

Vibration properties of the droplets 99a and 99b on the substrate 2 are described.

The minute droplets landed on the substrate 2 by the droplet discharge are given a surface shape of a part of a spherical surface by surface tension thereof. When the control device 25 applies vibration to these droplets via the piezo actuators 34-38, and 71-73, the holder 70 and the substrate 2, each of the droplets vibrates (resonates) at a natural frequency (resonance frequency) determined based on a droplet diameter, an elastic constant, a viscosity, a surface tension, a contact angle or the like. In the case where the droplets are continuously discharged from the droplet discharging head 20, physicalities of the droplets can be considered to be the same, and thus the specific number of the vibration of each of the droplets (vibration property) is determined based on only a diameter, and is expressed by the following formula.

$$f = c \sqrt{\frac{σ}{{R}^{3} ρ}} \qquad [ Formula 1 ]$$

Where f is a frequency, c is a constant, σ is a surface tension, ρ is a density, and R is a droplet radius.

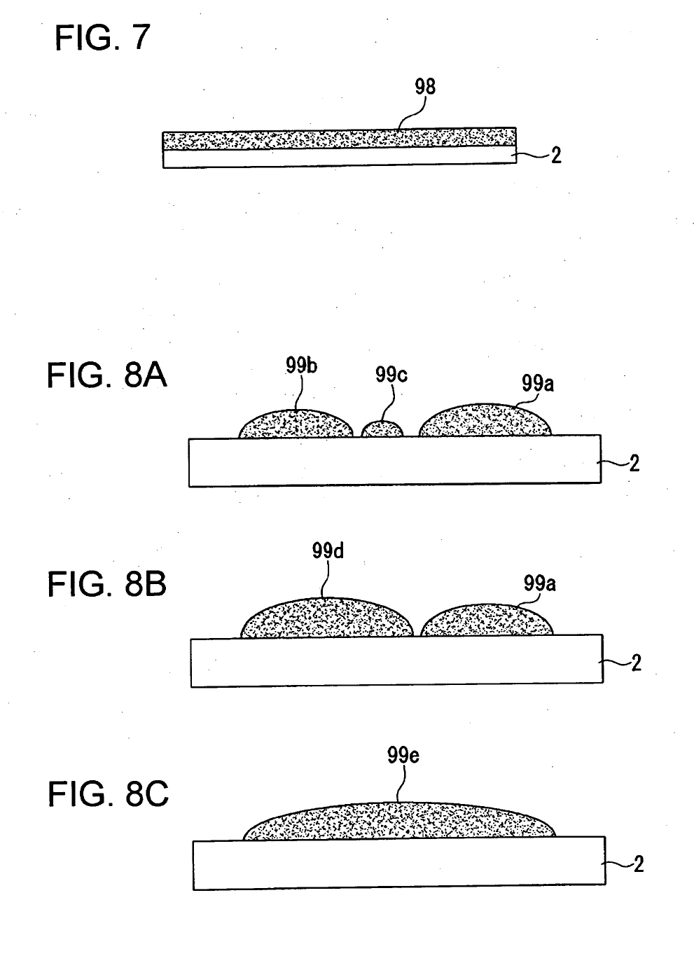

As shown above, since the natural frequency of the droplet is in proportion to the (−3/2) power of a diameter d (R×2), the droplets 99a and 99b having different diameters from each other vibrate at different frequencies. As a result, for example, the droplets 99a and 99b arranged adjacently to each other as shown in FIG. 6A collides with each other, thereby being fused as shown in FIGS. 6B and 6C. The fusion between the droplets makes a larger droplet, thereby changing a vibration cycle, and further the droplet collides with another droplet to be fused. In this manner, by repeating the collision and fusion between the droplets, as shown in FIG. 7, a planar film 98 having a uniform film thickness is formed on the substrate 2.

At this time, the diameters d of the droplets 99a and 99b are known and thus, for example, in the case where the control device 25 applies vibration via the piezo actuators 34-38 and 71-73, the holder 70 and the substrate 2 at a resonance frequency fb of the droplet 99b having a small diameter, if a resonance frequency fa of the droplet 99a is about (2×fb), the droplet 99a hardly moves and the droplet 99b moves largely, and thus the droplet 99b collides with the droplet 99a, thereby promoting the fusion between the droplets.

In this manner, in the present exemplary embodiment, since the droplets 99a and 99b of a plurality of sizes are applied on the substrate 2 and are vibrated with different vibration properties, the adjacent droplets can surely be caused to collide with each other and be fused. Therefore, in the present exemplary embodiment, a planar thin film having a uniform film thickness can be easily and surely formed, thereby reducing or preventing adverse effects on the properties of an element having this thin film and deterioration in display quality due to a so-called line feed streak. Furthermore, even when droplets of a material having a relatively large viscosity are applied, a uniform film thickness can be easily attained.

Furthermore, in the present exemplary embodiment, since the vibration is applied at a frequency based on the natural frequency of the droplet 99b, a difference in the movement between the droplets is large, and thus the droplets are efficiently caused to collide with each other, thereby promoting the fusion and shortening time until the droplet 99b resonates, which can contribute to enhancement in throughput.

### Second Exemplary Embodiment

In the above-mentioned first exemplary embodiment, a case where the vibration is applied to the droplets 99a and 99b of two sizes at a constant frequency is described, but in the present exemplary embodiment, a case where the vibration is applied while changing the frequency is described.

As shown in FIG. 8A, in the present exemplary embodiment, the droplets 99a-99c are applied in three sizes on the substrate 2 (the diameters are, 99a>99b>99c). The control device 25 controls the drive of the piezo actuators 34-38 and 71-73 to thereby change the frequency of applied vibration in a range including the natural frequency (resonance frequencies) fa, fb and fc (fa<fb<fc from the above formula) corresponding to the respective sizes of the droplets 99a through 99c.

At this time, the control device 25 changes (sweeps) the frequency from a higher value to a lower value. In this case, the droplet 99c whose resonance frequency is the highest first vibrates (resonates) largely, and for example, as shown in FIG. 8B, it collides with the adjacent droplet 99b, thereby fusing these droplets to form a droplet 99d. Furthermore, when the vibration frequency is changed to fb, similarly the droplet 99b resonates and collides with the adjacent droplet to be fused. When the frequency is further changed, the droplet 99a resonates and collides with the adjacent droplet to be fused.

At this time, for example, as shown in FIG. 8B, in the case where a diameter of the droplet 99d is larger than the droplet 99a, the droplet 99a first resonates and collides with the droplet 99d, so that as shown in FIG. 8C, a larger droplet 99e is formed. On the other hand, in the case where a diameter of the droplet 99a is larger than the droplet 99d, the droplet 99d first resonates and collides with the droplet 99a.

In this manner, in the present exemplary embodiment, since by changing the vibration frequency, the droplets of all the sizes can be sequentially resonated to collide with each other, the fusion of droplets can be effectively achieved, which can further contribute to the uniformization of the film thickness. In particular, in the present exemplary embodiment, since the vibration frequency is changed from a high frequency to a low frequency, the droplet whose natural frequency is reduced by the fusion can be resonated, and thus the droplets can be more effectively fused.

### Third Exemplary Embodiment

In a third exemplary embodiment, a case where a linear film is formed by vibration is described.

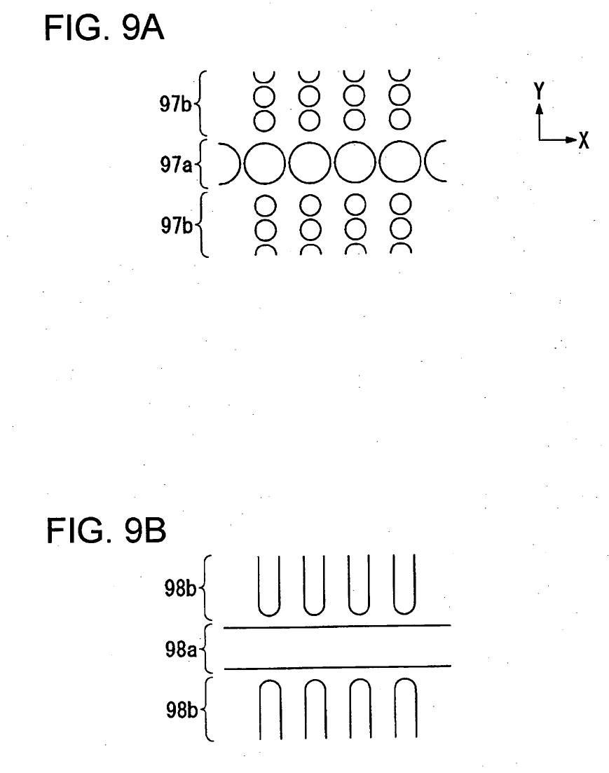

In the present exemplary embodiment, for example, as shown in FIG. 9A, a droplet group 97a having large diameters (first droplet group) of a plurality of sizes (at least adjacent droplets have different sizes) is applied along the X axial direction (first direction), and a droplet group 97b having small diameters (second droplet group) of a plurality of sizes (at least the adjacent droplets have different sizes) is applied along the Y axial direction (second direction) on both sides of the Y direction interposing the droplet group 97a.

The droplet group 97a is selected from sizes within a predetermined range (first range) to be applied, and the droplet group 97b is selected from sizes within a range (second range) different from that of the droplet group 97a to be applied.

Although the sizes of the droplets in the respective droplet groups 97a and 97b are different at least between the adjacent droplets, in FIG. 9A, the droplets in each of the groups are shown similarly in size for convenience.

The control device 25 drives the piezo actuators 36 through 38, thereby applying vibration to the droplet group 97b in the Y axial direction. At this time, by setting the vibration frequency to the resonance frequency fib of the droplet of the size within the second range, the droplet group 97b can be resonated with the droplets of the droplet group 97a hardly moved.

Thereby, the droplets in the droplet group 97b collide with each other and are fused, and as shown in FIG. 9B, a plurality of linear films (pattern) 98b extending in the Y axial direction are formed with a space therebetween in the X axial direction.

Furthermore, the control device 25 drives the piezo actuators 34 and 35, thereby applying the vibration to the droplet group 97a in the X axial direction. At this time, by setting the vibration frequency to the resonance frequency fa of the droplet of the size within the first range, the droplet group 97a can be resonated with the droplets of the droplet group 97b hardly moved.

Thereby, the droplets in the droplet group 97a collide with each other and are fused, and as shown in FIG. 9B, a linear film (pattern) 98a extending in the X axial direction is formed.

In this manner, in the present exemplary embodiment, by selecting the vibration direction and its frequency as necessary, the linear patterns extending in the X axial direction and the Y axial direction can be formed individually.

### Fourth Exemplary Embodiment

Next, as a device manufactured by manufacturing a thin film by the above-mentioned film forming method, a liquid crystal display device is described.

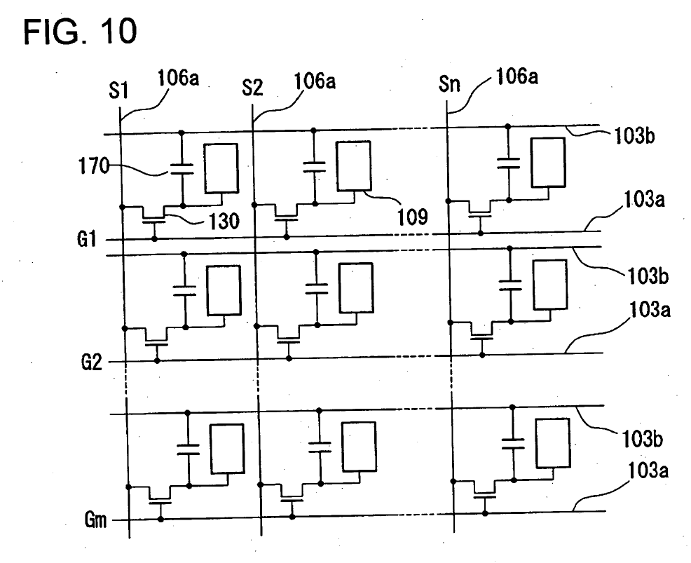

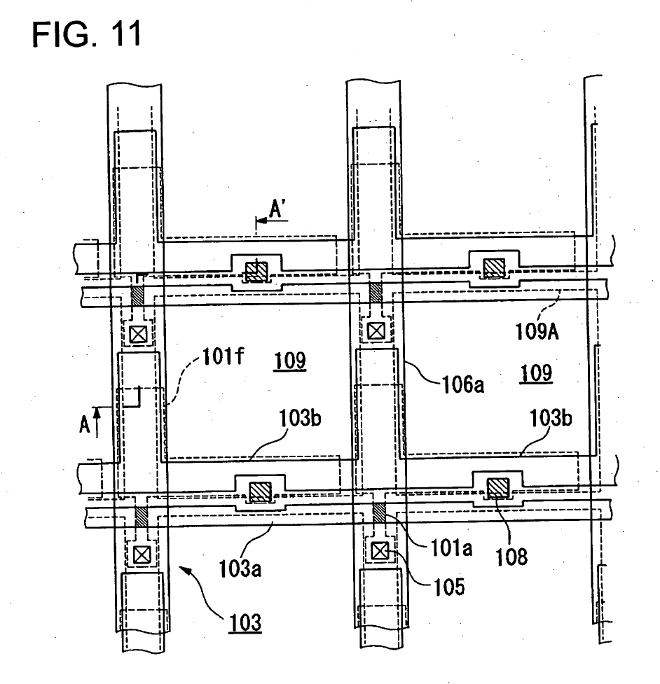

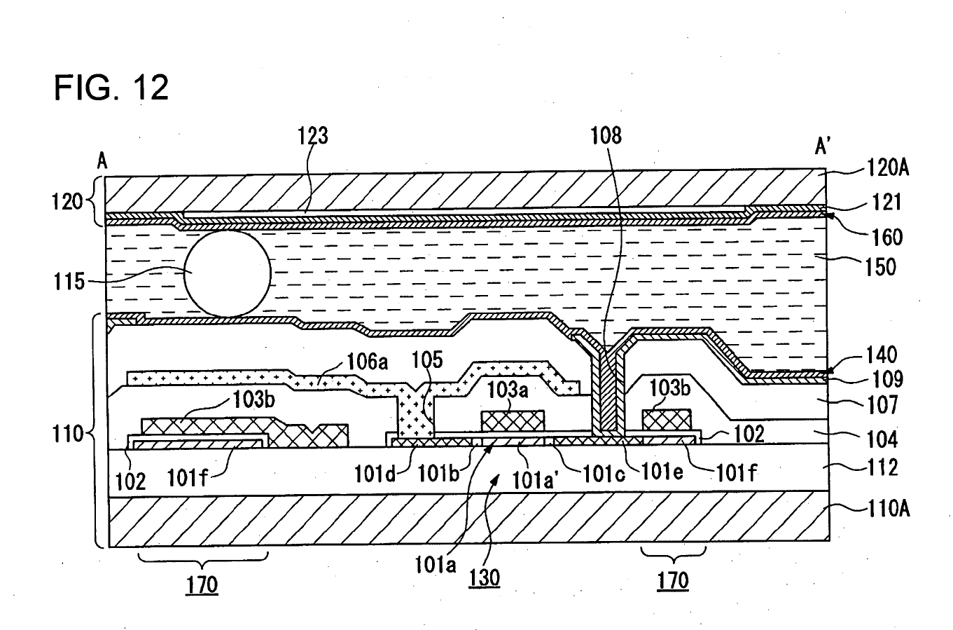

An exemplary embodiment of the present invention can be applied in manufacturing the liquid crystal display device shown in FIGS. 10 through 12. The liquid crystal display device of the present exemplary embodiment is an active matrix type transmissive liquid crystal device using a TFT (Thin Film Transistor) as a switching element. FIG. 10 is a schematic circuit diagram of switching elements, signal lines or the like in a plurality of pixels arranged in matrix in the transmissive liquid crystal device. FIG. 11 is a partial planar view showing a structure of a plurality of pixel groups adjacent to each other on a TFT array substrate on which data lines, scanning lines, and pixel electrodes or the like are formed. FIG. 12 is a cross-sectional view taken along plane A-A′ in FIG. 11. In FIG. 12, a case where the upper side in the figure is a light incident side, and the lower side in the figure is a viewing side (observer side) is shown. Furthermore, in the respective figures, since respective layers and members are shown in sizes recognizable in the drawings, scales are varied in the respective layers and members.

In the liquid crystal display device of the present exemplary embodiment, as shown in FIG. 10, in the plurality of pixels arranged in matrix, there are formed a pixel electrode 119 and a TFT element 130 which is a switching element to control energizing to the pixel electrode 109, respectively, and a data line 106a to which an image signal is supplied is electrically coupled to a source of the TFT element 130. Image signals S1, S2 . . . Sn to be written in the data line 106a are sequentially supplied in this order, or are supplied by group with respect to the plurality of data lines 106a adjacent to each other. Furthermore, a scanning line 103a is electrically coupled to a gate of the TFT element 130, and scanning signals G1, G2 . . . Gm are pulsatively impressed at predetermined timing to the plurality of scanning lines 103a in the line order. Furthermore, a pixel electrode 109 is electrically coupled to a drain of the TFT element 130, and by turning on the TFT element 130 which is a switching element only for a predetermined period, the image signals S1, S1 . . . Sn supplied from the data lines 106a are written at predetermined timing. The image signals S1, S2 . . . Sn at a predetermined level written in the liquid crystal via the pixel electrodes 109 are held between a common electrode described later for a predetermined timing. The liquid crystal modulates light by varying the orientation and order of molecular association depending on impressed voltage level, thereby enabling gray scale display. Here, in order to reduce or prevent the held image signals from leaking, a storage capacitance 170 is added in parallel to a liquid crystal capacitance formed between the pixel electrode 109 and the common electrode.

Next, referring to FIG. 11, a planar structure of a substantial part of the liquid crystal display device of the present exemplary embodiment is described. As shown in FIG. 11, on the TFT array substrate, the plurality of rectangular pixel electrodes 109 (the outlines are shown by broken line parts 109A) made of a transparent conductive material such as Indium Tin Oxide (hereinafter ITO) are provided in matrix, and the data line 106a, the scanning line 103a and capacitance line 103b are provided along the vertical and horizontal borders of the pixel electrodes 109, respectively. Each of the pixel electrodes 109 is electrically coupled to the TFT element 130 provided corresponding to each intersecting part of the scanning line 103a and the data line 106a, and this structure allows the display for each pixel. The data line 106a is electrically coupled via a contact hole 105 to a source region described later among a semiconductor layer 101a made of a polysilicon film, for example, which composes the TFT element 130, and the pixel electrode 109 is electrically coupled via a contact hole 108 to a drain region described later among the semiconductor layer 101a. Furthermore, the scanning line 103a is arranged so as to be opposed to a channel region (a region indicated by oblique lines inclined upward as going to the left in the figure) described later among the semiconductor layer 101a, and the scanning line 103a functions as a gate electrode at the part opposing the channel region. The capacitance line 103b has a main line part extending substantially linearly along the scanning line 103a (that is, as viewed planarly, a first region formed along the scanning line 103a), and a projected part which is projected on a preceding stage side (upward in the figure) along the data line 106a from a portion intersecting with the data line 106a (that is, as viewed planarly, a second region provided extensively along the data line 106a).

Next, referring to FIG. 12, a cross-sectional structure of the liquid crystal display device of the present exemplary embodiment is described. FIG. 12, as described above, is a cross-sectional view along plane A-A′ in FIG. 11, showing a structure of a region where the TFT element 130 is formed. In the liquid crystal display device of the present exemplary embodiment, a liquid crystal layer 150 is interposed between a TFT array substrate 110 and a counter substrate 120 arranged in opposition to this. The TFT array substrate 110 is mainly composed of a translucent substrate body 110A, the TFT element 130 formed on a surface of the substrate body on the liquid crystal layer 150 side, the pixel electrode 109, and an orientation film 140, and the counter substrate 120 is mainly composed of a translucent plastic substrate 120A, a common electrode 121 formed on a surface of the plastic substrate on the liquid crystal layer 150 side, and an orientation film 160.

The respective substrates 110 and 120 are held at a predetermined substrate interval (gap) via a spacer 115. In the TFT array substrate 110, the pixel electrode 109 is provided on a surface of the substrate body 110A on the liquid crystal layer 150 side, and at a position adjacent to each of the pixel electrode 109, the TFT element 130 for pixel switching which performs switching control over each of the pixel electrode 109 is provided.

The TFT element 130 for pixel switching has an LDD (Lightly Doped Drain) structure, and the scanning line 103a, a channel region 101a′ of the semiconductor layer 101a where a channel is formed by electric field from the scanning line 103a, a gate insulating film 102 insulating the scanning line 103a and the semiconductor layer 101a, the data line 106a, a low concentration source region 101b, a low concentration drain region 101c of the semiconductor layer 101a and a high concentration source region 101d and a high concentration drain region 101e of the semiconductor layer 101a. On the substrate body 110A including surfaces of the scanning line 103a and the gate insulating film 102, there is formed a second interlayer insulating film 104 where the contact hole 105 coupled to the high concentration source region 101d and the contact hole 108 coupled to the high concentration drain region 101e are opened. In other words, the data line 106a is electrically coupled to the high concentration source region 101d via the contact hole 105 penetrating the second interlayer insulating film 104. Furthermore, on the data line 106a and the second interlayer insulating film 104, there is formed a third interlayer insulating film 107 where the contact hole 108 coupled to the high concentration drain region 101e is opened. That is, the high concentration drain region 101e is electrically coupled to the pixel electrode 109 via the contact hole 108 penetrating the second interlayer insulating film 104 and the third interlayer insulating film 107.

In the present exemplary embodiment, the gate insulating film 102 is provided extensively from a position opposed to the scanning line 103a and is used as a dielectric film, and the semiconductor film 101a is provided extensively to serve as a first storage capacitance electrode 101f, and further a part of the capacitance line 103b opposed to these serves as a second storage capacitance electrode, thereby composing the storage capacitance 170. Furthermore, between the TFT array substrate 110A and the TFT element 130 for pixel switching, there is formed a first interlayer insulating film 112 for electrically insulating the semiconductor layer 101a, which composes the TFT element 130 for pixel switching, from the TFT array substrate 110A. Furthermore, on a top surface of the TFT array substrate 110 on the liquid crystal layer 150 side, that is, on the pixel electrode 109 and the third interlayer insulating film 107, the orientation film 140 controlling the orientation of liquid crystal molecules in the liquid crystal layer 150 during impressing no voltage is formed.

Accordingly, a region including such a TFT element 130 is structured such that in the top surface of the TFT array substrate 110 on the liquid crystal layer 150 side, that is, on the surface interposing the liquid crystal layer 150, a plurality of irregularities or steps are formed. On the other hand, in regard to the counter substrate 120, on the a surface of the substrate body 120A on the liquid crystal layer 150 side, in a region opposed to the forming region (non-pixel region) of the data line 106a, the scanning line 103a and the TFT element 130 for pixel switching, there is provided a second light shielding film 123 to reduce or prevent incident light from entering the channel region 101a′, the low concentration source region 101b and the low concentration drain region 101c of the semiconductor layer 101a of the TFT element 130 for pixel switching. Furthermore, on the liquid crystal layer 150 side of the substrate body 120A where the second light shielding film 123 is formed, the common electrode 121 made of ITO or the like is formed over substantially all the surface, and on the liquid crystal layer 150 side thereof, the orientation film 160 controlling the orientation of the liquid crystal molecules in the liquid crystal layer 150 during impressing no voltage is formed.

In the present exemplary embodiment, by applying droplets containing metal fine particles using the above-mentioned film forming method, the data line 106a, the scanning line 103a composing the gate electrode, the capacitance line 103b, the pixel electrode 109 or the like can be formed, and by applying droplets of a liquid crystal composition, the liquid crystal layer 150 can be formed. Furthermore, by applying droplets containing an orientation film forming material, the orientation films 140 and 160 can be formed.

The metal wiring formed by the above-mentioned film forming method has a uniform film thickness with less irregularity, and thus adverse effects on properties of elements, such as an increase in electric resistance, can be reduced or prevented.

Furthermore, the liquid crystal layer and the orientation film formed by the above-mentioned film forming method are films having less irregularity, and thus occurrence of display unevenness or the like due to film thickness unevenness can be reduced or prevented, thereby contributing to enhancement in quality.

### Fifth Exemplary Embodiment

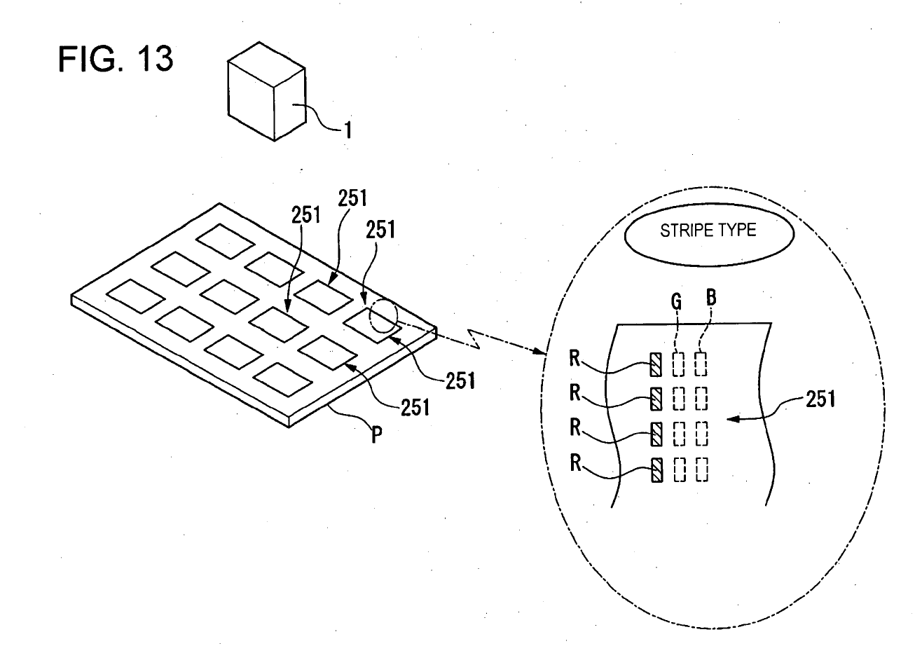

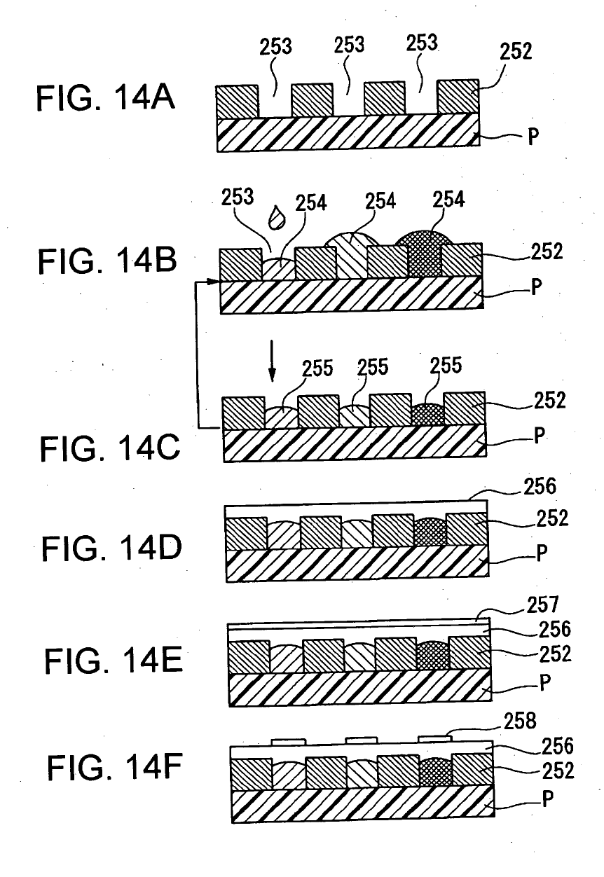

An exemplary embodiment of the present invention can be used to form a film serving as a component of a color filter. Referring to FIGS. 13-14F, an example of manufacturing a color filter by a drawing process and a thin film forming process (film forming process) is described.

FIG. 13 is a schematic showing the color filter formed on a substrate P, and FIGS. 14A-14F are schematics showing a manufacturing procedure of the color filter. As shown in FIG. 13, in this example, a plurality of color filter regions 251 are formed in matrix on the rectangular substrate P in terms of enhancing the productivity. These color filter regions 251 can be used as color filters adapted to the liquid crystal display device by cutting the substrate P later. The color filter regions 251 are obtained by forming a liquid composition of R (red), a liquid composition of G (green), and a liquid composition of B (blue) in predetermined patterns, respectively, specifically in the present example, in related art or publicly known conventional striped type patterns.

As these forming patterns, in addition to the striped type, a mosaic type, a delta type, a square type or the like may be employed.

In order to form these color filter regions 251, as shown in FIG. 14A, banks 252 are first formed on one surface of the transparent substrate P. In a forming method of these banks 252, exposure and development are performed after spin coat. The banks 252 are formed into a lattice shape in plan view, and inside of the bank surrounded by the lattice, ink is arranged. At this time, the banks 252 preferably have a liquid repellency. In addition, the banks 252 preferably function as black matrix.

Next, as shown in FIG. 14B, droplets 254 of a liquid composition are discharged from the droplet discharging head to land in filter elements 253. The amount of the droplets 254 to be discharged is set to a sufficient value, taking into consideration a volume reduction of the liquid composition in a heating step. In this manner, after the droplets 254 are charged into all the filter elements 253 on the substrate P, the substrate P is heat-treated to a predetermined temperature (for example, 70° C.) using a heater. By this heat-treatment, a solvent of the liquid composition evaporates and the liquid composition is reduced in volume. In the case where this volume reduction is intensive, the droplet discharging step and the heating step are repeated until a sufficient film thickness as a color filter is obtained. By this process, the solvent contained in the liquid composition evaporates, and finally, only solid contents contained in the liquid composition remain to form a film, thereby composing color filters 255 as shown in FIG. 14C.

Next, in order to make the substrate P plane and protect the color filters 255, as shown in FIG. 14D, a protective film 256 is formed on the substrate P so as to cover the color filters 255 and the banks 252. When forming this protective film 256, although methods, such as a spin coat method, a roll coat method, and a ripping method can be employed, the droplet discharging method can also be performed as in the color filters 255. Next, as shown in FIG. 14E, on the whole surface of this protective film 256, a transparent conductive film 257 is formed by a sputtering method, a vacuum deposition method or the like. Thereafter, the transparent conductive film 257 is patterned, and as shown in FIG. 14F, pixel electrodes 258 are patterned corresponding to the filter elements 253. In the case where a TFT (Thin Film Transistor) is used to drive a liquid display panel, this patterning is unnecessary.

In the present exemplary embodiment, when forming the color filters 255, the pixel electrodes 258, or the protective film 256, the film forming method and the device manufacturing method of an exemplary embodiment of the present invention can be applied.

In the present exemplary embodiment, the liquid compositions of R, G and B are applied to the corresponding color filter regions 251 using the above-mentioned film forming method to thereby manufacture the color filters. Thereby, the color filters having a substantially uniform film thickness with less irregularity can be obtained, and enabling enhancement in display quality.

Furthermore, by forming the protective film 256 using the above-mentioned film forming method, the surface can be made plane, and thus the display quality can be enhanced.

Furthermore, the present invention is not limited to the manufacturing of the above-mentioned color filter for liquid crystal display, but as an example of the device, the invention can be applied to form a metal wiring in a plasma type display device, an EL (electroluminescence) display device or a semiconductor device.

The EL display device is an element having a structure that a thin film containing a fluorescent organic and inorganic compounds is interposed between a negative electrode and a positive electrode, and electrons and holes are injected into the thin film to rebond them, thereby generating excitons, and that light emission (fluorescence/phosphorescence) when these excitons are deactivated are used to emit light. In such an EL display element, a hole injection layer, a light emitting layer, a sealing layer, a transparent electrode or the like can be formed using the above-mentioned film forming method.

The scope of the devices in an exemplary embodiment of the present invention include these EL display devices and plasma type display devices.

### Sixth Exemplary Embodiment

As a sixth exemplary embodiment, specific examples of electronic equipment of the present invention are described.

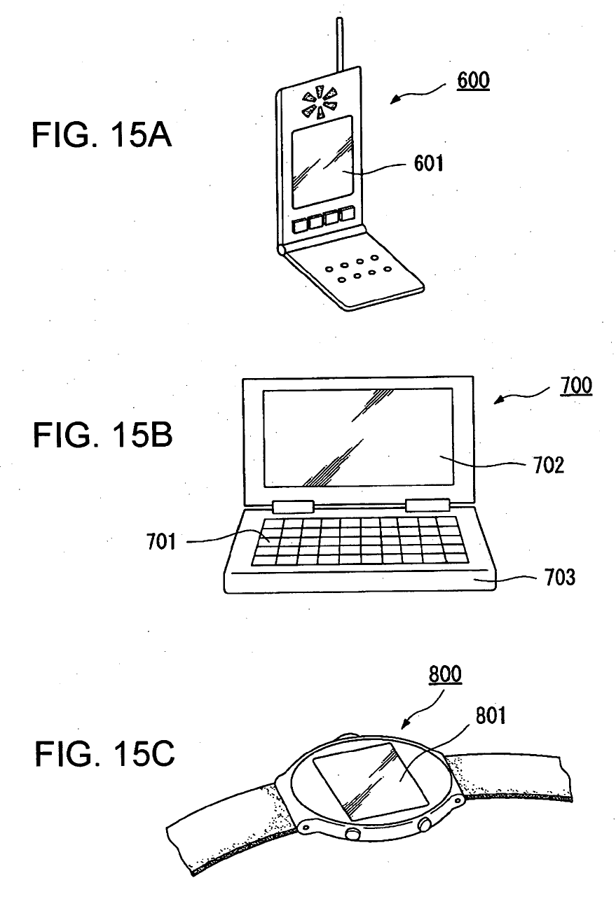

FIG. 15A is a perspective view showing an example of a cellular phone. In FIG. 15A, reference numeral 600 denotes a cellular phone body, and reference numeral 601 denotes a liquid crystal display part including a liquid crystal display device of the above-mentioned exemplary embodiment.

FIG. 15B is a perspective view showing an example of portable information processing device, such as a word processor and a personal computer, for example. In FIG. 15B, reference numeral 700 denotes an information processing device, reference numeral 701 denotes an input part, such as a keyboard, reference numeral 703 denotes an information processing body, and reference numeral 702 denotes the liquid crystal display part including the liquid crystal display device of the above-mentioned exemplary embodiment.

FIG. 15C is a perspective view showing an example of a wrist watch type of electronic equipment. In FIG. 15C, reference numeral 800 denotes a watch body, reference numeral 801 denotes the liquid crystal display part including the liquid crystal display device of the above-mentioned exemplary embodiment.

Since the electronic equipment shown in FIGS. 15A-15C include the liquid crystal display device of the above-mentioned exemplary embodiment, high quality can be attained.

Although the electronic equipment of the present exemplary embodiments include the liquid crystal device, the electronic equipment can include another electro-optic apparatus, such as an organic electro luminescence display device, a plasma type display device, etc.

Although as described above, the exemplary embodiments according to the present invention are explained referring to the attached drawings, needless to say, the present invention is not limited to these examples. In the above-mentioned examples, the shapes, the combinations or the like of the each described components are an example, and various modifications can be made based on design demand or the like within the scope not departing from the gist of the present invention.

For example, although in the above-mentioned exemplary embodiments, the cases where a color filter and metal wiring are formed by the film forming method of the present invention are described, in addition to these cases, the present invention can also be applied to a case where an optical element, such as a light guide, is formed on a substrate, and when a resist or a micro lens array is formed.

1. A film forming method in which a plurality of droplets are applied to a substrate to form a film, the method comprising:
applying the droplets to the substrate in a plurality of sizes; and
vibrating the droplets on the substrate with vibration properties different from each other.

2. The film forming method according to claim 1, the vibrating including vibrating the droplets at a frequency based on a natural frequency of the droplets of at least one size among the droplets of a plurality of sizes.

3. The film forming method according to claim 2, further including changing the frequency in a range including all natural frequencies corresponding to the sizes of the droplets.

4. The film forming method according to claim 3, further including changing the frequency from a higher value to a lower value.

5. The film forming method according to claim 1, further comprising:
applying a first droplet group made of droplets of a plurality of sizes within a first range along a first direction;
applying a second droplet group made of droplets of a plurality of sizes within a second range different from the first range along a second direction;
applying vibration in the first direction at a frequency based on the natural frequency of the droplets of the sizes within the first range; and
applying vibration in the second direction at a frequency based on the natural frequency of the droplets of the sizes within the second range.

6. A device manufacturing method, comprising:
forming a thin film on a substrate, the forming including using the film forming method according to claim 1.

7. A device manufactured by the device manufacturing method according to claim 6.

8. Electronic equipment, comprising:
the device according to claim 7.

9. A film forming machine for use with a droplet discharging head discharging droplets on a substrate, comprising:
a control device to control the drive of the droplet discharging head to discharge the droplets on the substrate in a plurality of sizes; and
a vibration applying device to vibrate the droplets on the substrate with different vibration properties.

10. A device manufacturing apparatus, comprising:
a film forming machine to form a thin film on a substrate, the film forming machine including the film forming machine according to claim 9.
